(19) United States
(12) Patent Application Publication
(10) Pub. No.: US 2004/0094336 A1
(43) Pub. Date: May 20, 2004

(54) Method and device for weighing the content of a metallurgical vessel, particularly the content of a distributing launder in steel continuous casting installations

(76) Inventors: Axel Weyer, Wuppertal (DE); Peter Boese, Moers (DE); Hans Jurgen Hecken, Schuld (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/471,267

(22) PCT Filed: Jan. 30, 2002
(86) PCT No.: PCT/EP02/00914

(30) Foreign Application Priority Data
Mar. 9, 2001 (DE) 101 11 294.7

(51) Int. Cl. G01G 19/52

(52) U.S. Cl. 177/132

(57) ABSTRACT

A method and a device for weighing the contents of a metallurgical vessel (2), especially the contents of a tundish (3) in a steel continuous casting plant, whereby the vessel is supported on hydraulically actuatable weighing elements serving to increase the measurement precision before and during the metallurgical process and resides in that the filling weight is calculated by computer from hydraulic pressures in cylinder chamber (8a; 9a; 10a; 11a) which are measured deducting the empty weight of the vessel (2) and the friction forces in the cylinder chambers (8a; 9a; 10a; 11a).

The invention relates to a method and a device for weighing the contents of a metallurgical vessel, especially the contents of a tundish in a steel continuous-casting plant, whereby the vessel is supported on hydraulically actuatable weighing elements.

The weighing of the tundish, as an intermediate vessel upstream of the continuous casting mold in continuous casting plants serves for the acquisition of the actual degree of filling or filling weight in casting operations. The filling state or the filling weight are continuously monitored as process values and used to control the course of casting startup and the continuous casting operations also during sequential castings.

Such a process and a customary device for carrying it out is known (Austrian patent 367 330), whereby a force-measurement unit is provided with a force-measuring cell between the swingable levers of a ladle turntable which carries the ladle within a continuous-casting plant. The hydraulic weighing elements, which are comprised of the force-measuring cells are arranged between the load-takeup device and the levers. This arrangement should avoid the friction forces at the pivot axes and thus the falsification of the measured values. The measured values obtained, however, cannot be reproducible in all cases because of the characteristics of the force-measuring cells.

A pickup and weighing device for casting ladles (German patent document 43 44 367 A1) has a support frame of a transport device. The ladle loops rest upon support feet in a support trough and are braced upon receiving surfaces of a weighing beam through weighing elements. Measurement value falsifications arise here because of the friction losses at many locations. The damping cylinders which are provided for load damping serve only to enable clean setting down of the casting ladle and cannot provide a model for an exact measurement.

The invention has as its object to provide a method and a device for a precise measurement of its content not only at the beginning of a metallurgical process but also during the course of a process.

The stated object is achieved, according to the invention in that the filling weight is determined by computer from the hydraulic pressures measured in cylinder chambers, deducting the weight of the vessel and the friction forces in the cylinder chambers and/or in vertical guides. In this manner the contents of the vessel at the beginning and during the metallurgical process can be measured very precisely. In addition it is possible to take into consideration an extremely large number of parameters which can falsify the measurement results.

It is advantageous for the metallurgical process and thus for its control that the hydraulic pressures are continuously measured.

To enable other parameters to be taken into consideration, the net hydraulic pressures are recalculated as force values corresponding to the geometrical cylinder dimensions.

One such inclusion of a further parameter is accomplished by determining the empty weight of the vessel before beginning the casting operation as a base value (zero value) and electronically storing it.

A device for weighing the contents of a metallurgical vessel, especially the contents of a tundish in a steel continuous casting apparatus in which the vessel rests on hydraulically actuatable weighing elements, achieves the object set forth in is accordance with the invention in that the vessel is supported by means of one or more hydraulic piston-cylinder units vertically and transversely, free from ancillary force effects, and in that pressure measuring devices are connected to the cylinder chambers. In this manner, the basic conditions for precise measurement results can be obtained.

In individual cases it can also be advantageous that the pressure measuring devices are disposed in the cylinder chambers themselves. The measurement results thus are especially precise because of the proximity to the pressure medium.

A further feature for increasing the measurement precision resides in that the vessel is supported by means of four symmetrically distributed piston and cylinder units.

The pressure measurement can also be so carried out that the piston-cylinder units are continuously controlled in parallel to maintain a predetermined position via hydraulic control valves.

Advantageously to support the reproducibility of precise measurement results in the device, in addition, the friction forces of the piston-cylinder units can be obtained as friction characteristics [characteristic graphs] and electronically stored.

Such an increase in the measurement precision and the reproducibility arises also when the empty weight of the vessel is electronically storable with corresponding weight parts of the support structure.

In the drawing an embodiment of the invention has been illustrated and is described in greater detail below.

The drawing shows:

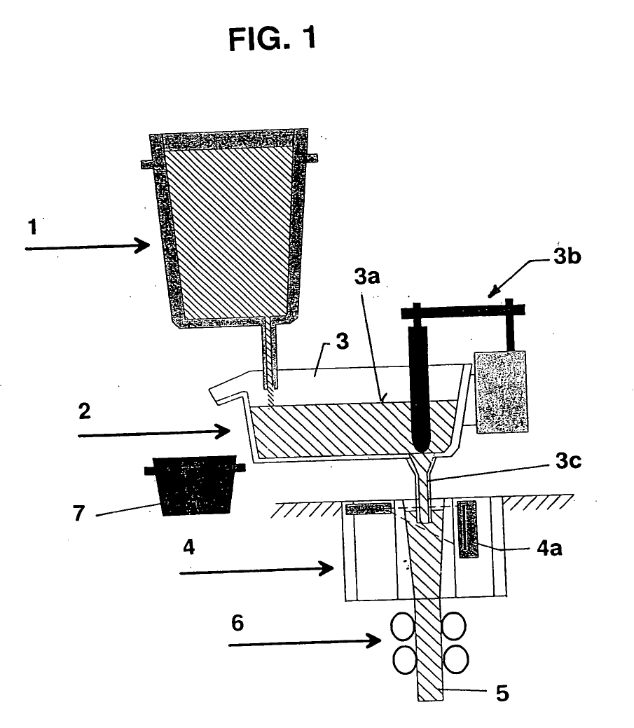

FIG. 1 a vertical section through a continuous casting device with casting ladle, tundish, continuous casting mold, strand guide and cast strand; and

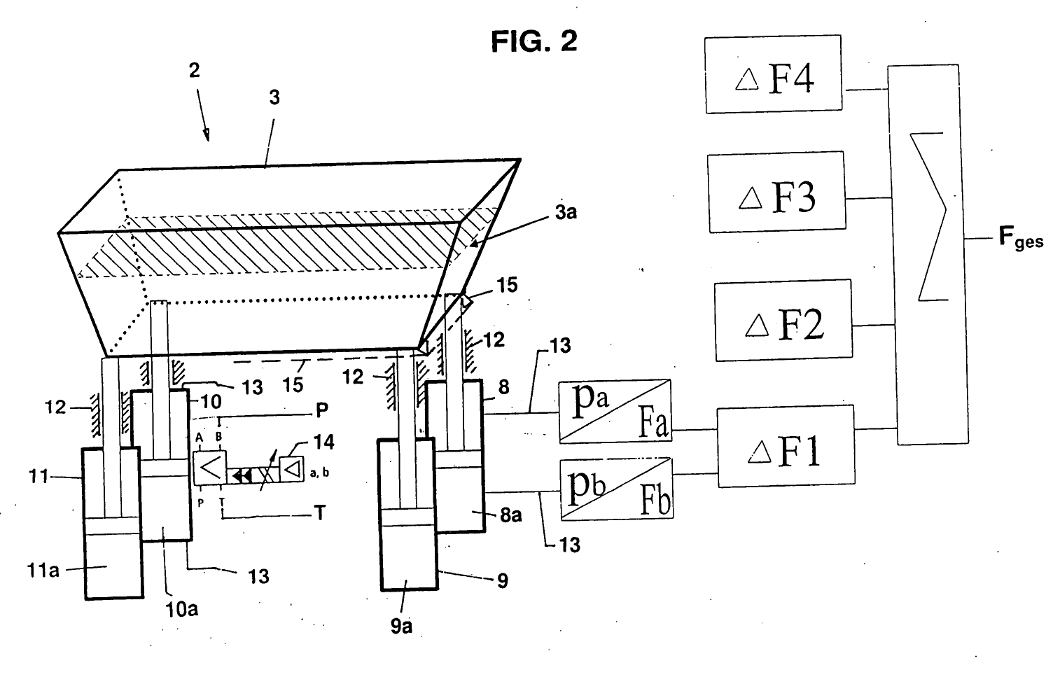

FIG. 2 a weighing device in connection with which the method for weighing is described.

The liquid metal, for example molten steel, flows out of a ladle 1 into a metallurgical vessel 2 which in the example is comprised of a tundish 3 in which the molten steel is retained to a filling level 3a by means of a filling level measuring device. The molten steel flows through a stopper control 3b and a submerged tube 3c into a continuous casting mold 4 in which the casting level (melt level) is regulated by a casting level measuring device 4a. The cast strand 5 then passes into a strand guide 6 residual slag skimmed from the tundish 3 is collected in a slag bucket 7 (FIG. 1).

The method of weighing a metallurgical vessel in order to obtain values for the weight of the molten metal is applied to the tundish 3 itself, in that the vessel 2 is supported on hydraulically actuatable weighing elements. These weighing elements are comprised of piston-cylinder units 8, 9, 10 and 11, which each have cylinder chambers 8a, 9a, 10a and 11a. For weighing the filling weight is calculated by computer from measurement of the hydraulic pressures in the cylinder chambers 8a, 9a, 10a and 11a, whereby the hydraulic pressures are measured deducting the empty weight of the vessel 2 and the friction forces having their origins in for example the friction of the pistons and piston rods. The hydraulic pressures can be continuously measured. It is also possible to convert the net hydraulic pressures into force values based upon the geometrical cylinder dimensions. The empty weight value of the vessel 2 can be determined and electronically stored before the beginning of the casting operation as a base value (zero value).

From the detected pressures Pₐ or Fₐ, for each piston-cylinder unit 9-11, the force ΔF1 through ΔF4 is measured and calculated and the total sum F_{ges} is formed. This fixes the instantaneous value of the contents of the tundish 3.

The device for the described weighing process for the metallurgical vessel 2, that is in the illustrated embodiment the tundish 3 utilizes hydraulically actuatable weighing elements upon which the vessel 2 is supported. The support is such that the vessel 2 is supported by means of one or more hydraulic-piston cylinder units 8, 9, 10, 11 vertically and transversely, free from all other force effects and that pressure measuring devices 13 are connected to the cylinder chambers 8a through 11a.

In exceptional cases the pressure measuring devices 13 may be disposed in the cylinder chambers 8a, 9a, 10a, 11a themselves.

In the embodiment, the vessel 2 is supported by means of is four symmetrically distributed piston-cylinder units 8, 9, 10, 11 (FIG. 2). The piston-cylinder units 8, 9, 10 and 11 are controlled in parallel via hydraulic control valves 14 with feed connections P and returns T continuously and to a predetermined position.

The vertical guides 12, for example as formed by the piston rods, develop friction forces for the piston cylinder units 8, 9, 10 and 11 are taken up as friction characteristics and electronically stored. The empty weight of the vessel 2 can also be electronically stored along with the corresponding weight factors of components the support structure 15 and can be taken into consideration in the calculation of the filling weight.

The method of operating and the device can also be used or other metallurgical vessels under the described conditions.

Reference Character List

| | |
|---|---|
| 1 | Ladle |
| 2 | Metallurgical Vessel |
| 3 | Tundish |
| 3a | Fill Level Measuring Device |
| 3b | Plug Control |
| 3c | Submerged Tube |
| 4 | Continuous Casting Mold |
| 4a | Casting Level Measuring Device |
| 5 | Casting Strand |
| 6 | Strand Guide |
| 7 | Slag Bucket |
| 8 | Piston-Cylinder Unit |
| 8a | Cylinder Chamber |
| 9 | Piston-Cylinder Unit |
| 9a | Cylinder Chamber |
| 10 | Piston-Cylinder Unit |
| 10a | Cylinder Chamber |
| 11 | Piston-Cylinder Unit |
| 11a | Cylinder Chamber |
| 12 | Vertical Guide |
| 13 | Pressure Measuring Device |
| 14 | Hydraulic Control Valve |
| 15 | Carrying Device |

1. A method of weighing a metallurgical vessel, especially a tundish in a steel continuous casting apparatus, whereby the vessel is supported on hydraulically actuatable weighing elements, characterized in that the filling weight is determined by computer from hydraulic pressures in cylinder chamber (8a; 9a; 10a; 11a) measured with deduction of the empty weight of the vessel (2) and the friction forces in the cylinder chamber (8a; 9a; 10a; 11a) and/or in vertical guides (12).

2. A method according to claim 1 characterized in that the hydraulic pressures are continuously measured.

3. A method according to one of claims 1 or 2 characterized in that the net hydraulic pressures are recalculated in force values corresponding to the geometrical cylinder dimensions.

4. A method according to one of claims 1 through 3 characterized in that the empty weight value of the vessel (2) is determined and electronically stored before beginning the casting operation as a base value (zero value).

5. A device for weighing the contents of a metallurgical vessel, especially the contents of a tundish in steel continuous casting apparatus, whereby the vessel rests on hydraulically actuatable weighing elements characterized in that the vessel (2) is supported by means of one or more hydraulic piston-cylinder units (8, 9, 10, 11) vertically and transversely, free from other forces, and that pressure measuring devices (13) are connected to the cylinder chambers (8a, 9a; 10a; 11a).

6. A device according to claim 5 characterized in that the pressure measuring devices (13) are disposed in the cylinder chambers (8a, 9a, 10a, 11a) themselves.

7. A device according to one of the claims 5 or 6 characterized in that the vessel (2) is supported by means of four symmetrically distributed piston-cylinder units (8, 9, 10, 11).

8. A device according to one of claims 5 through 7, characterized in that the piston-cylinder units (8, 9, 10, 11) are controllable continuously to a predetermined position in parallel by hydraulic control valves (14).

9. A device according to one of the claims 5 through 8 characterized in that the friction forces of the piston-cylinder units (8, 9, 10, 11) are detected as friction characteristics and electronically stored.

10. A device according to one of the claims 5 through 9 characterized in that the empty weight of the vessel (claim 2) with corresponding weight parts of the structural support (15) are electronically storable.
